(19) United States
(12) Patent Application Publication
(10) Pub. No.: US 2007/0290071 A1
(43) Pub. Date: Dec. 20, 2007

(54) Structure of a sprinkler

(75) Inventors: Hsin-Fa Wang, Chang Hua Hsien (TW); Mei-Ying Wu, Hemei Township (TW)

Correspondence Address: EGBERT LAW OFFICES, 412 MAIN STREET, 7TH FLOOR, HOUSTON, TX, 77002, US

(73) Assignee: Hsin-Fa WANG, Lu Kang Town (TW)

(21) Appl. No.: 11/442,707

(22) Filed: May 30, 2006

(51) Int. Cl. B05B 15/06

(52) U.S. Cl. 239/275; 239/394; 239/233; 239/279

(57) ABSTRACT

The present invention provides an improved structure of a sprinkler. The invention has a water storage space inside the sprinkler base, so that the water flows into the sprinkler base through water pipe connector. The water fills up the water storage space first and then flows into the sprinkler unit. The sprinkler base is weighed down with water without having other blocks to secure it. The invention not only saves cost but also secures the base as well, which makes it more practical.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an improved structure of a sprinkler, and more particularly to an invention that has a water storage space added inside the sprinkler base.

### BACKGROUND OF THE INVENTION

A sprinkler is different than a regular water gun. It is placed on a fixed spot on the ground, and the sprinkler uses a sprinkler unit to achieve the purpose of irrigation within the predetermined area.

The conventional structure of a sprinkler is shown in FIGS. 1 and 2. The main body 11 of the sprinkler 10 is usually a cover, and one side of the main base 11 has a water pipe connector 12. The water pipe connector 12 has a water channel 13 towards an inside of the main body, as shown in FIG. 2. This conventional structure 10 of sprinkler still has problems.

First, the main base 11 of the sprinkler is a cover that is usually made of plastic material. Thus, the cover is light weight. When the water pressure reaches the main base 11 and the water flow turns from horizontal to vertical, it is often hard to secure the sprinkler base 11. The sprinkler 10 is unable to stay on the fixed location, affecting irrigation of the predetermined area.

The current solution in the industry is to place a heavy block on a particular location of the sprinkler base 11. This method obviously increases the cost of the material, production and assembly, which is not practical.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The improved fact of the present invention is explained herein.

The present invention uses a unique structure that has a water storage space 40 added inside the sprinkler base 20, so that when the water flow is guided into the sprinkler base 20 from the water pipe connector 21, it first fills up the water storage space 40. The weight of the water inside the space 40 is used to secure the sprinkler base 20. The sprinkler base 20 is weighed down with water without having other blocks to secure it. The invention not only saves cost but also secures the base, which makes it more practical.

The new effect of the present invention is explained herein.

The present invention uses several positioning grooves 25 that are lined up around the wall of the slot 24 of the sprinkler base 20. A positioning protruding spot 34 is placed on the side of the column joint 33. In this structure, the distance and numbers of the positioning groove 25 corresponds to the sprinkler hole 31 at the top of the overflow basin 30. When any of the water inlet holes 32 at the bottom of the overflow basin 30 correspond to the water outlet hole 23 of the supporting surface 22 of the sprinkler base 20, the positioning protruding spot 34 of the column joint 33 can be locked in with the positioning groove 25 that corresponds to the slot 24. When the overflow basin 30 turns to the next sprinkler hole 31, it moves to the next positioning groove 25 by the positioning protruding spot 34 to position it. By each movement of the sprinkler, the positioning function is accurately achieved.

### BRIEF DESCRIPTION OF THE SEVERAL VIEWS OF THE DRAWINGS

FIG. 1 shows a perspective view of the conventional structure.

FIG. 2 shows a sectional view of the conventional structure.

FIG. 3 shows an assembled perspective view of the preferred embodiment of the present invention.

FIG. 4 shows an exploded perspective view of the primary component of the preferred embodiment of the present invention.

FIG. 5 shows an exploded sectional view of the primary component of the preferred embodiment of the present invention.

FIG. 6 shows an assembled sectional view of the primary component of the preferred embodiment of the present invention.

FIG. 7 shows a schematic view of a diagram of the positioning of the column joint of the overflow basin of the present invention.

FIG. 8 shows a schematic view of a diagram of the positioning of the column joint of the overflow basin of the present invention.

FIG. 9 shows a partial perspective and sectional view of another preferred embodiment of the present invention.

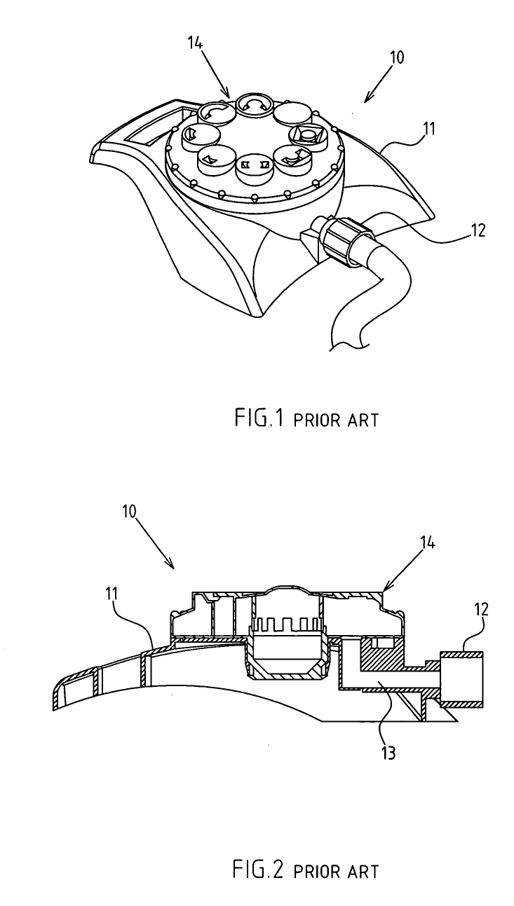

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

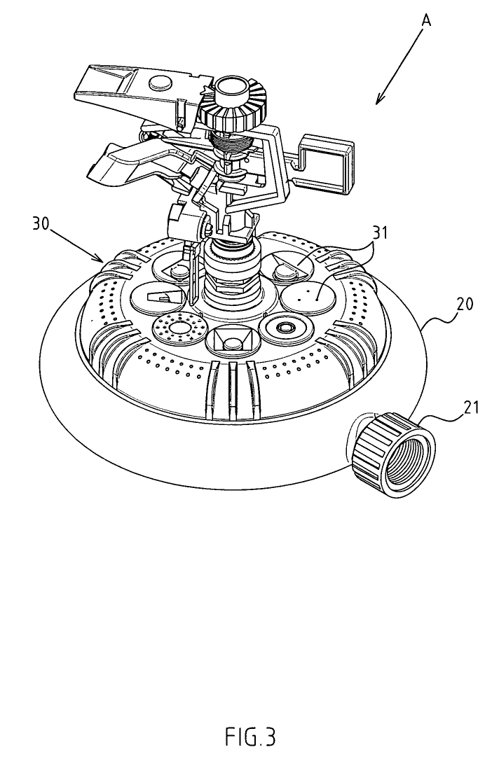

As shown in FIGS. 3-5, there is a preferred embodiment of an improved structure of a sprinkler.

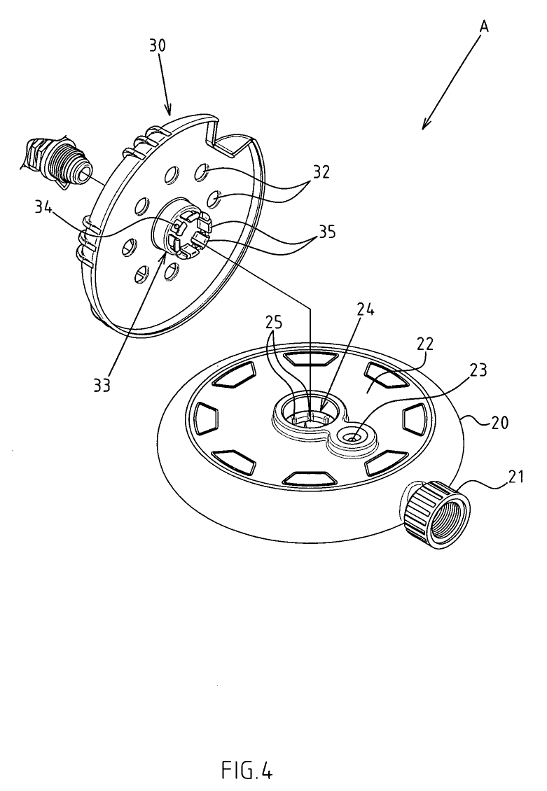

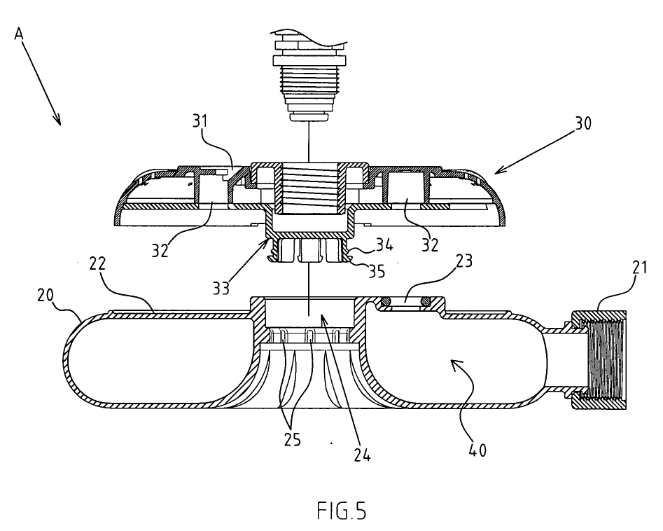

The invention includes a sprinkler base 20, which has a water pipe connector 32 placed on one side, and a supporting surface 22 (as shown in FIG. 4) on the top end. A water outlet hole 23 is placed on the supporting surface 22, and a tube shaped slot 24 is placed in the center of the sprinkler base 20. Several positioning grooves 25 are lined up around the wall of the slot 24, and the positioning grooves 25 mentioned herein can be semi-circular slots.

A sprinkler unit, in this embodiment, is a overflow basin 30, which comprises several sprinkler holes 31 lined up around its top part. Several water inlet holes 32 are connected to each sprinkler hole at the bottom. A column joint 33 is placed in the center of the bottom of the overflow basin 31, so that it can be locked in the slot 24 of the sprinkler base 30. By so doing, the overflow basin 30 can turn but can not separate from the sprinkler base 30. At least a positioning protruding spot 34 is placed on the side of the column joint 33, so that it is locked into the positioning grooves 25 that correspond to the slot 24 mentioned above when the overflow basin 30 is turning. The distance and numbers of the positioning groove 25 corresponds to the sprinkler hole 31 at the top of the overflow basin 30. For example, in this embodiment, there are 8 sprinkler holes 31; therefore, there are 8 positioning grooves 25. When the overflow basin 30 turns to the next sprinkler hole 31, it moves to the next positioning groove 25 by the positioning protruding spot 34 to position the basin 30. The column joint 33 comprises several elastic hooks 35 lined up in a circular shape, so that the positioning protruding spot 34 may be placed on the external side of a elastic hook 35.

A water storage space 40 is placed inside the sprinkler base 20, and the water storage space 40 is connected to the water pipe connector 21 and water outlet hole 23. Among them, the water storage space 40 of the present invention has a slot 24 in the center of the sprinkler base 20 that is designed in a circular shape. The water storage space 40 can be formed by sprinkler base 20, such as a blowing method. Moreover, the sprinkler base 20 can also be made by a top and a bottom cover, such as high frequency press or sealed ring, to shape the water storage space 40.

Through the above structure and design, the operation of the present invention is explained herein.

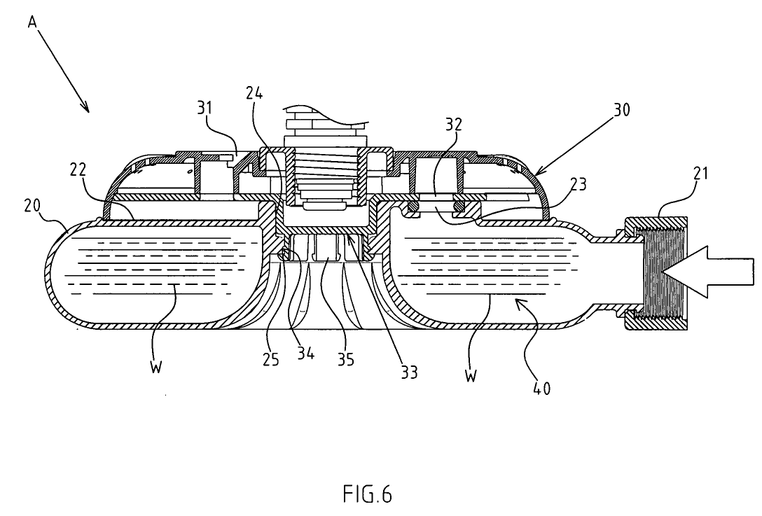

The primary feature of the present invention is the water storage space 40 added inside the sprinkler base 20. By this invention, as shown in FIG. 6, when the sprinkler base A is being used, and when the water flow W comes out of the water pipe connector 21 to fill inside the sprinkler base 20, the water flows into the water storage space 40 first. After it fills up the water storage space 40, it flows into the water inlet hole 32 from the water outlet hole 23 at the supporting surface 22, and then into the overflow basin. When the water flow W fills up the water storage space 40, it uses the weight of the water to secure the sprinkler base 20, so that it is not separated easily.

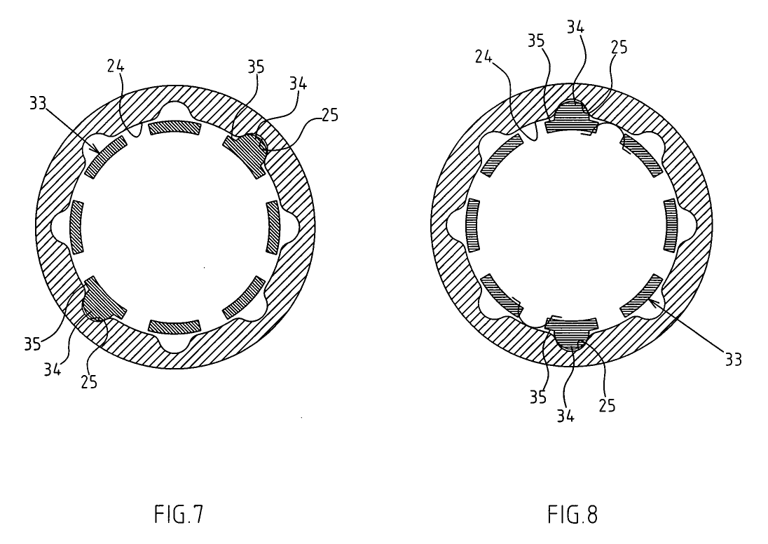

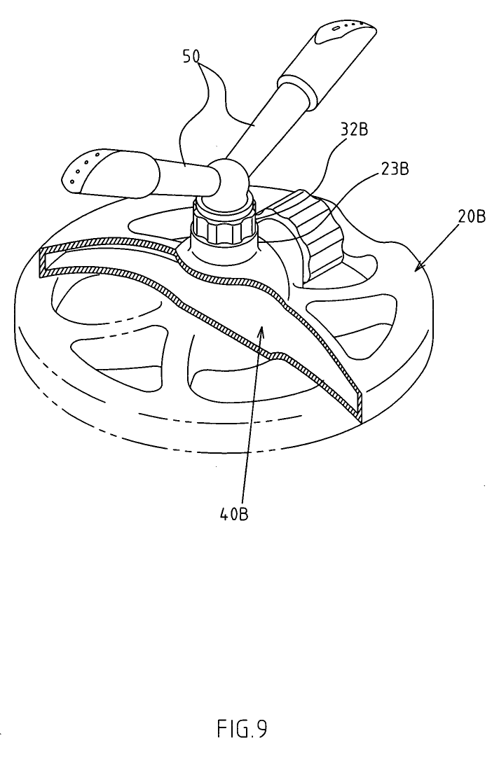

Another feature of the present invention is that the positioning grooves 25 are lined up around the wall of the slot 24 of the sprinkler base 20, and a positioning protruding spot 34 is placed on the side of the column joint 33. By this invention, the distance and numbers of the positioning groove 25 corresponds to the sprinkler hole 31 at the top of the overflow basin 30. When any of the water inlet hole 32 at the bottom of the overflow basin 30 corresponds to the water outlet hole 23 of the supporting surface 22 of the sprinkler base 20, the positioning protruding spot 34 of the column joint 33 can be locked in with the positioning groove 25 that corresponds to the slot 24, as shown in FIG. 7. When the overflow basin 30 turns to the next sprinkler hole 31, it moves to the next positioning groove 25 by the positioning protruding spot 34 to position the basin 30, as shown in FIG. 8.

As shown in FIG. 9, there is another embodiment of the structure of the present invention. There are two main differences between this embodiment and the embodiment mentioned above. First, the water storage space 40B of the sprinkler base 20B has a multiple forked shaped to achieve the expected weight of the water storage. Second, the sprinkler unit of the sprinkler base 20B is a forked sprinkler 50, and the forked sprinkler 50 connects to a water outlet 32B, equivalent to the water inlet hole 32 of the other embodiment, through a water guide 32B, also equivalent to the water inlet hole 32 of the other embodiment.

We claim:

1. A structure of a sprinkler, said structure comprising:
a sprinkler base, having a water pipe connector placed on one side thereof and a water outlet hole placed on a predetermined area thereof;
a sprinkler unit, being placed on said predetermined area of said sprinkler base and being comprised of a water inlet hole and at least one sprinkler hole, said water inlet hole being connected to said water outlet hole of said sprinkler base;
a water storage space, being placed inside said sprinkler base, said water storage space being connected to said water pipe connector and said water outlet hole.

2. The structure defined in claim 1, wherein said water storage space is made integral with said sprinkler base.

3. The structure defined in claim 1, further comprising:
positioning grooves, wherein distance and numbers of said positioning grooves correspond to each sprinkler hole of an overflow basin.

4. A structure of a sprinkler, said structure comprising:
a sprinkler base, having a water pipe connector placed on one side thereof, a supporting surface on a top end thereof, a water outlet hole placed on said supporting surface, and a tube shaped slot placed in a center of said sprinkler base, said tube shaped slot having several positioning grooves lined up around a wall thereof;
a overflow basin, being comprised of several sprinkler holes lined up around a top part thereof, and several water inlet holes connected to each sprinkler hole at a bottom thereof;
a column joint being placed in a center bottom of said overflow basin and being locked in the slot of said sprinkler base, said overflow basin being turnable and not separable from said sprinkler base, said column joint having at least a positioning protruding spot placed on a side thereof, said column joint being locked in to said positioning grooves corresponding to the slot when said overflow basin is turning, positioning said overflow basin; and
a water storage space, being placed inside said sprinkler base, said water storage space being connected to said water pipe connector and said water outlet hole.

5. The structure defined in claim 4, wherein said water storage space is a circular space.

6. The structure defined in claim 4, wherein said water storage space is made integral with said sprinkler base.

7. The modified structure defined in claim 4, further comprising:
positioning grooves, wherein distance and numbers of said positioning grooves correspond to each sprinkler hole of an overflow basin.
